(19) United States
(12) Patent Application Publication
(10) Pub. No.: US 2025/0360700 A1
(43) Pub. Date: Nov. 27, 2025

(54) QUANTUM-DOT OPTICAL FILM AND THE METHOD TO MAKE THE SAME

(71) Applicant: UBRIGHT OPTRONICS CORPORATION, Taoyuan City (TW)

(72) Inventors: Chia-Yeh Miu, Taoyuan City (TW); Ge-Wei Lin, Taoyuan City (TW); Chia-Jung Chiang, Taoyuan City (TW); Lung-Pin Hsin, Taoyuan City (TW); Ying-Yi Lu, Taoyuan City (TW); Jeffrey Wu, Taoyuan City (TW); Hui-Yong Chen, Taoyuan City (TW)

(21) Appl. No.: 19/289,089

(22) Filed: Aug. 3, 2025

Related U.S. Application Data
(63) Continuation of application No. 17/727,703, filed on Apr. 23, 2022, now abandoned.
(60) Provisional application No. 63/179,158, filed on Apr. 23, 2021.

(51) Int. Cl. B32B 27/18; B32B 23/20; B32B 27/08; B32B 27/30; B32B 27/36

(52) U.S. Cl. CPC B32B 27/18; B32B 23/20; B32B 27/08; B32B 27/308; B32B 27/36; B32B 27/365; B32B 2255/10; B32B 2255/26; B32B 2264/10; B32B 2264/1026; B32B 2264/1027; B32B 2264/201; B32B 2307/7242; B32B 2307/732; B32B 2457/20

(57) ABSTRACT

A quantum-dot optical film comprising: a binder, wherein a plurality of quantum dots, a plurality of diffusing particles, and a plurality of clay fragments are dispersed in the binder, wherein each of the clay fragments is capable of being water-resistant and oxygen-resistant.

### CROSS-REFERENCE TO RELATED APPLICATIONS

This application is a continuation application of patent application Ser. No. 17/727,703, filed on Apr. 23, 2022, which claims the benefit of U.S. provisional patent application No. 63/179,158, filed on Apr. 23, 2021, which is hereby incorporated herein by reference.

### BACKGROUND OF THE INVENTION

### 1. Field of the Invention

The present invention relates to an optical film, and more particularly to a quantum-dot optical film.

### 2. Description of Related Art

The quantum dot is a semiconductor particle having a nanometer size and a spherical shape. The colored spectrum can be generated when the quantum dots are excited by light or electricity. The color of the excited light is determined according to the material and the size of the quantum dot. Because quantum dots can change the color of the light emitted by a light source, they can be widely used in display devices, such as liquid crystal displays (LCD). The quantum dots can enhance the color gamut, the color, and the brightness of the display device such that the display device can have a color gamut of about 110% NTSC (National Television System Committee).

The quantum dot is commonly made of IV, II-VI, IV-VI, or III-V elements, such as Si, Ge, CdS, CdSe, CdTe, ZnSe, PbS, PbSe, InP, and InAs, where the most widely used are mainly CdSe and InP. QD Vision mainly uses CdSe as the material of the quantum dot, Nanoco mainly uses InP as the material of the quantum dot and Nanosys uses a combination of CdSe and InP as the material of the quantum dot.

The conventional barrier film, for protecting the quantum dot layer, is made by sputtering by expensive vacuum equipment. Furthermore, there is often a problem with adhesion between the surface of the quantum dot layer and the surface of the conventional barrier film that needs a surface adhesion treatment. Although the surface of nano-quantum dots is protected by organic gametes, it is easily eroded by external water and oxygen molecules, which causes the organic gametes to detach from the central metal core and produce surface defects, which ultimately affect their luminous efficiency and stability.

Accordingly, the present invention proposes a new solution to overcome the above-mentioned disadvantages.

### SUMMARY OF THE INVENTION

In one embodiment, the present invention discloses a quantum-dot optical film, wherein the quantum-dot optical film comprises: a quantum-dot layer, comprising: a binder, wherein a plurality of quantum dots are dispersed in the binder; a first coating layer, wherein the first coating layer is formed by coating a first material on a top surface of the quantum-dot layer, said first material comprising a first polymer and a first plurality of clay fragments in the first polymer, wherein each of the first plurality of clay fragments is capable of being water-resistant and oxygen-resistant; a second coating layer, wherein the second coating layer is formed by coating a second material on a bottom surface of the quantum-dot layer, said second material comprising a second polymer and a second plurality of clay fragments disposed in the polymer, wherein each of the second plurality of clay fragments is capable of being water-resistant and oxygen-resistant.

In one embodiment, the present invention discloses a quantum-dot optical film, wherein the quantum-dot optical film comprises: a quantum-dot layer, comprising a binder and a plurality of quantum dots dispersed in the binder; a first base film; and a first coating layer, wherein a top surface of the first coating layer is coated on a bottom surface of the base film, wherein a bottom surface of the first coating layer is laminated on a top surface of the quantum-dot layer, wherein the first coating layer comprises an acrylic resin and inorganic clay fragments dispersed in the acrylic resin, wherein each of the clay fragments is capable of being water-resistant and oxygen-resistant.

In one embodiment, the quantum-dot optical film comprises a second coating layer, wherein a bottom surface of the second coating layer is coated on a top surface of the second film, wherein a top surface of the second coating layer is laminated on a bottom surface of the quantum-dot layer, wherein the second coating layer comprises an acrylic resin and inorganic clay fragments dispersed in the acrylic resin, wherein each of the clay fragments is capable of being water-resistant and oxygen-resistant.

In one embodiment, the clay fragment is composed of multiple silicate layers.

In one embodiment, the quantum-dot layer further comprises a plurality of diffusing particles dispersed in the binder.

In one embodiment, the binder comprises PET (polyethylene terephthalate).

In one embodiment, the present invention discloses a method to form a quantum-dot optical film, wherein the method comprises: forming a quantum-dot layer, wherein the quantum-dot layer comprises a binder, wherein a plurality of quantum dots are dispersed in the binder; forming a first coating layer by coating a first material on a top surface of the quantum-dot layer, said first material comprising polymer and clay fragments in the polymer, wherein each of the clay fragments is capable of being water-resistant and oxygen-resistant.

In one embodiment, the method further comprises forming a second coating layer by coating a second material on a bottom surface of the quantum-dot layer, said second material comprising a polymer and clay fragments in the polymer, wherein each of the clay fragments is capable of being water-resistant and oxygen-resistant.

In one embodiment, the present invention discloses a method to form a quantum-dot optical film, said method comprising: mixing layered-structure inorganic clay and acrylic resin to form a mixture, wherein the layered-structure inorganic clay is dispersed in the acrylic resin, wherein the inorganic clay is capable of being water-resistant and oxygen-resistant; wet coating the mixture on a plastic film to form an optical film of mixed organic/inorganic composite material through cross-linking reaction; and laminating the optical film with a quantum-dot resin layer to form a quantum-dot optical film.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a schematic cross-sectional view of a quantum-dot optical film;

FIG. 2 illustrates a schematic cross-sectional view of the quantum-dot optical film according to one embodiment of the present invention;

FIG. 3A illustrates a schematic cross-sectional view of the quantum-dot optical film according to one embodiment of the present invention;

FIG. 3B illustrates a schematic cross-sectional view of the quantum-dot optical film according to one embodiment of the present invention;

FIG. 3C illustrates a schematic cross-sectional view of the quantum-dot optical film according to one embodiment of the present invention;

FIG. 4 illustrates a method to form a quantum-dot optical film according to one embodiment of the present invention;

FIG. 5 illustrates a method to form a quantum-dot optical film according to one embodiment of the present invention;

FIG. 6 illustrates a chart to compare the penetrating rate of different barrier films;

FIG. 7 illustrates a chart to compare the luminance of different barrier films;

FIG. 8 illustrates a chart to compare the x-color degradation of different barrier films;

FIG. 9 illustrates a chart to compare the y-color degradation of different barrier films;

### DETAILED DESCRIPTION OF THE ILLUSTRATED EMBODIMENTS

The detailed explanation of the present invention is described as follows. The described preferred embodiments are presented for purposes of illustrations and descriptions, and they are not intended to limit the scope of the present invention.

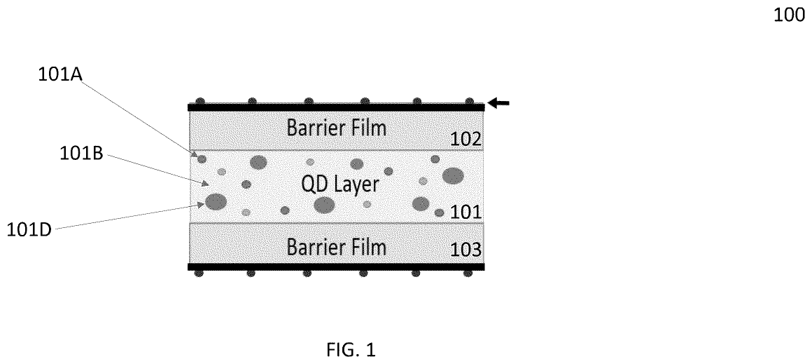

The quantum dots in the quantum-dot optical film are highly sensitive to degradation, so the quantum-dot film should have excellent barrier properties to prevent damage to the quantum dots in the quantum-dot optical film caused by oxygen or water, which degrades the performance of the quantum-dot optical film. Conventionally, see FIG. 1, the quantum-dot optical film 100 includes a first barrier layer 102, a second barrier layer 103, and a quantum-dot layer 101 comprising a binder 101B being located between the first barrier layer 102 and the second barrier layer 103. A plurality of quantum dots 101A are dispersed in the binder 101B. The barrier layers 102, 103 can protect the quantum dots 101A from damage caused by oxygen or water. In addition, diffusion particles 101D can be disposed in the binder 101B.

In recent years, plastic filling and modification is an emerging industry in the plastics industry. With the rapid development of the plastics industry, the past single filling masterbatch technology has been developed to add inorganic materials, chemical additives, and other types of materials to make them highlight their respective characteristics and compatibility, and through advanced process technology Such as high temperature mixing and extrusion film stretching technology, has become one of the important ways to modernize the special properties of plastic products. The functionality of inorganic materials is also given novel and unique properties along with the miniaturization of nanoscale, which can further improve the physical and mechanical properties of composite plastics.

The filler of nanocomposite materials is currently a two-dimensional layered structure, which has many characteristics that traditional composite materials do not have, such as high gas barrier properties, low hygroscopicity, and nanoscale dispersion scale. The polymer properties are greatly improved. The natural clay (clay) is composed of multiple silicate layers, which can be evenly distributed in the polymer substrate, forcing the gas molecules not to diffuse in a straight line and need to detour, thus increasing the gas barrier properties of the substrate. This filling modification technology can also be applied to the field of optical films. In contemporary display technology, the high color gamut and high purity of popular quantum dot backlights can create a more realistic and balanced color performance. However, for the quantum dot optical film used in this technology, the upper and lower layers need to use a traditional gas barrier film to protect the middle quantum dot adhesive layer. In addition, the traditional gas barrier film preparation method is to vaporize and deposit inorganic oxides (sputtering or vapor deposition) on the surface of the PET film, and the process technology is expensive. At the same time, the production process of the quantum dot film product is cumbersome, which greatly affects the production process. The applicability and popularization of the optical film are limited.

One objective of the present invention is to develop a coated barrier film, which is an inorganic layered clay with anti-water and oxygen function through surface modification, and the nano-scale is dispersed into the cross-section of acrylic resin. It can form a nano-scale dispersed organic-inorganic composite film through coating technology, which also can achieve a good light-emitting effect and light-emitting uniformity.

The barrier coating composition includes a monomer combination comprising a first monomer having an acrylate and a second monomer having an acrylate, and a plurality of organo-modified clay particles dispersed in the monomer combination. The barrier coating composition may contain less than 10% total organic solvent based on the total weight of the composition.

Clay particles may include smectite, mica clay, vermiculite clay, montmorillonite clay, iron-containing montmorillonite clay, beidellite clay, saponite clay, hectorite clay, pyroxene clay, chlorite Stone clay, anionic clay, zirconium phosphate, kaolinite, attapulgite, illite, halloysite, diatomaceous earth, fuller's earth, calcined aluminum silicate, hydrated aluminum silicate, aluminum magnesium silicate, sodium silicate and silicon magnesium acid, or a combination thereof. Quantum dot-polymer composites can have any shape or size, but are typically spherical, elliptical, polyhedral, rod-shaped, or irregular in shape. For example, the quantum dot-polymer composite can have the shape of a sheet, strip, tube or tube.

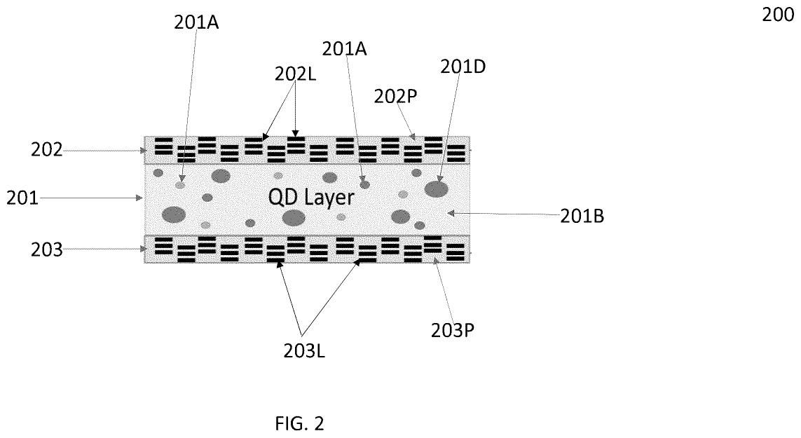

FIG. 2 illustrates a schematic cross-sectional view of the quantum-dot optical film 200 according to one embodiment of the present invention. The quantum-dot optical film 200 comprises a quantum-dot layer 201 and a first coating layer 202 and a second coating layer 203, wherein the quantum-dot layer 201 comprises a binder 201B and a plurality of quantum dots 201A dispersed in the binder 201B, wherein the first coating layer 202 is disposed on a top surface of the quantum-dot layer 201, and the second coating layer 203 is disposed on a bottom surface of the quantum-dot layer 201, wherein, wherein the first coating layer 202 is formed by coating a first material on a top surface of the quantum-dot layer 201, said first material comprising a first polymer 202P and a first plurality of clay fragments 202L in the first polymer 202P, wherein each of the first plurality of clay fragments 202L is capable of being water-resistant and oxygen-resistant, and wherein the second coating layer 203 is formed by coating a second material on a bottom surface of the quantum-dot layer 201, said second material comprising a second polymer 203P and a second plurality of clay fragments 203L disposed in the second polymer 203P, wherein each of the first plurality of clay fragments 203L is capable of being water-resistant and oxygen-resistant.

In one embodiment, the outer surface of each of the first plurality of clay fragments 202L is processed so that the clay fragment is capable of being water-resistant and oxygen-resistant.

In one embodiment, a plurality of diffusing particles 201D are dispersed in the binder 201B of the quantum-dot layer 201.

In one embodiment, the diffusion particles comprise organic particles, wherein, the concentration of the diffusion particles is 2 to 40 wt %.

In one embodiment, the diffusion particles comprise organic particles, wherein, the concentration of the diffusion particles is 5-15 wt %.

In one embodiment, the first polymer comprises an acrylic resin.

In one embodiment, the second polymer comprises an acrylic resin.

In one embodiment, the acrylic resin comprises a monomer (Monomer) type.

In one embodiment, the acrylic resin comprises a multi-body (Oligomer) type.

In one embodiment, the binder 201B of the quantum-dot layer 201 comprises PET (polyethylene terephthalate).

In one embodiment, the plurality of quantum dots 201A comprises red quantum dots and green quantum dots.

In one embodiment, the concentration of the quantum dots 201A in the quantum-dot layer 201 is 0.05-20%.

In one embodiment, the concentration of the quantum dots in the quantum-dot layer is 0.05-8%.

In one embodiment, the thickness of the optical film is in a range of 25-350 um.

In one embodiment, the binder 201B of the quantum-dot layer 201 at least one of the following: PET (polyethylene terephthalate), PEN (polyethylene naphtholate), PAR (polyacrylate), PC (polycarbonates), or TAC (cellulose triacetate).

In one embodiment, the clay fragment is composed of multiple silicate layers.

In one embodiment, the clay fragments comprise at least one of the following materials: glass flakes, mica, montmorillonite, talc, calcium silicate, aluminum silicate.

In one embodiment, the thickness of the first coating layer is in a range of 5-60 um.

In one embodiment, the thickness of the optical film is in a range of 60-350 um.

In one embodiment, the concentration of the quantum dots in the quantum-dot layer is 0.05-20 wt %.

In one embodiment, the concentration of the quantum dots in the quantum-dot layer is 0.05-8 wt %.

In one embodiment, the quantum dots comprise cadmium (Cd).

In one embodiment, the concentration of the Cd is 0.1 to 20 wt %.

In one embodiment, the concentration of the Cd is 0.3 to 8 wt %.

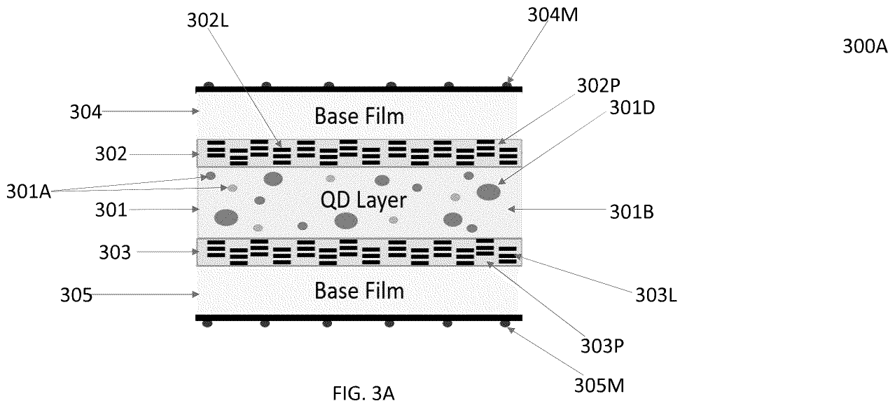

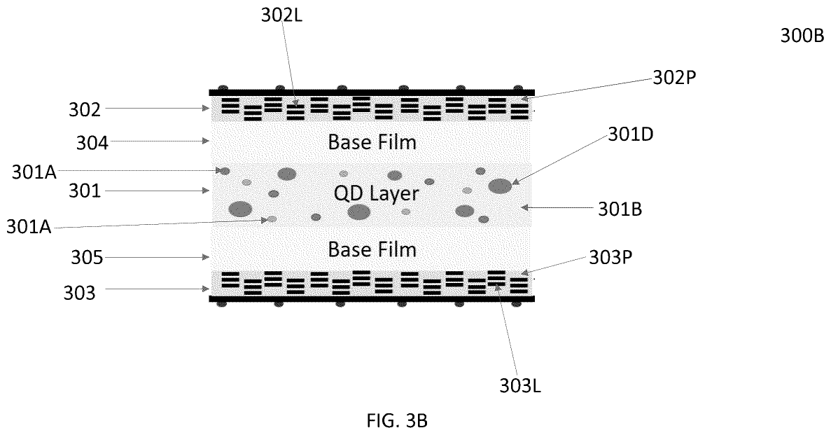

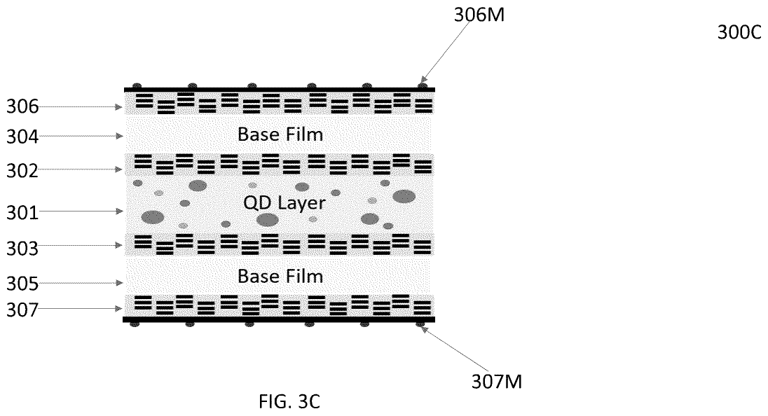

FIG. 3A illustrates a schematic cross-sectional view of the quantum-dot optical film 300A according to one embodiment of the present invention, wherein a quantum-dot optical film 300A comprises: a quantum-dot layer 301, comprising a binder 301B and a plurality of quantum dots 301A dispersed in the binder 301B; a first base film 304 such as an optical film; and a first coating layer 302, wherein a top surface of the first coating layer 302 is coated on a bottom surface of the base film 304, wherein a bottom surface of the first coating layer 302 is laminated on a top surface of the quantum-dot layer 301, wherein the first coating layer 302 comprises a first polymer and inorganic clay fragments dispersed in the first polymer, wherein each of the clay fragments is capable of being water-resistant and oxygen-resistant, wherein the first base film 304 and the first coating layer 302 coated on the first base film 304 forms a first optical barrier film comprising the first base film 304 and the first coating layer 302.

In one embodiment, as shown in FIG. 3A, the quantum-dot optical film 300A further comprises a second coating layer 303 and a second base film 305, wherein a bottom surface of the second coating layer 303 is coated on a top surface of the second base film 305, wherein a top surface of the second coating layer 303 is laminated on a bottom surface of the quantum-dot layer 301, wherein the second coating layer 303 comprises a second polymer and inorganic clay fragments dispersed in the second polymer, wherein each of the clay fragments is capable of being water-resistant and oxygen-resistant, wherein the second base film 305 and the second coating layer 303 coated on the second base film 305 forms a second optical barrier film comprising the second base film 305 and the second coating layer 303.

FIG. 3B illustrates a schematic cross-sectional view of the quantum-dot optical film 300B according to one embodiment of the present invention, wherein a quantum-dot optical film 300B comprising: a quantum-dot layer 301, comprising a binder 301B and a plurality of quantum dots 301A dispersed in the binder 301B; a first base film 304; and a first coating layer 302, wherein a bottom surface of the base film 304 is disposed on a top surface of the quantum-dot layer 301, wherein the first coating layer 302 is coated on a top surface of the first base film 304, wherein the first coating layer 302 comprises a first polymer and inorganic clay fragments dispersed in the first polymer, wherein each of the clay fragments is capable of being water-resistant and oxygen-resistant.

In one embodiment, as shown in FIG. 3B, the quantum-dot optical film 300B further comprises a second coating layer 303 and a second base film 305, wherein a top surface of the second base film 305 is disposed on a bottom surface of the quantum-dot layer 301, wherein the second coating layer 303 is coated on a bottom surface of the second base film 305, wherein the second coating layer 303 comprises a second polymer and inorganic clay fragments dispersed in the second polymer, wherein each of the clay fragments is capable of being water-resistant and oxygen-resistant.

FIG. 3C illustrates a schematic cross-sectional view of the quantum-dot optical film 300C according to one embodiment of the present invention, wherein a quantum-dot optical film 300C comprising: a quantum-dot layer 301, comprising a binder 301B and a plurality of quantum dots 301A dispersed in the binder 301B; a first base film 304; and a first coating layer 302, wherein a top surface of the first coating layer 302 is coated on a bottom surface of the base film 304, wherein a bottom surface of the first coating layer 302 is laminated on a top surface of the quantum-dot layer 301, wherein the first coating layer 302 comprises a first polymer and inorganic clay fragments dispersed in the first polymer, wherein each of the clay fragments is capable of being water-resistant and oxygen-resistant.

In one embodiment, as shown in FIG. 3C, the quantum-dot optical film 300C further comprises a second coating layer 303 and a second base film 305, wherein the second coating layer 303 is coated on a top surface of the second base film 305, wherein a top surface of the second coating layer 303 is laminated on a bottom surface of the quantum-dot layer 301, wherein the second coating layer 303 comprises a second polymer and inorganic clay fragments dispersed in the second polymer, wherein each of the clay fragments is capable of being water-resistant and oxygen-resistant.

In one embodiment, as shown in FIG. 3C, the quantum-dot optical film 300C further comprises a third coating layer 306 that is coated on a top surface of the first base film 304, wherein the third coating layer 306 comprises a third polymer and inorganic clay fragments dispersed in the third polymer, wherein each of the clay fragments is capable of being water-resistant and oxygen-resistant.

In one embodiment, as shown in FIG. 3C, the quantum-dot optical film 300C further comprises a fourth coating layer 307 that is coated on a bottom surface of the second base film 305, wherein the fourth coating layer 307 comprises a fourth polymer and inorganic clay fragments dispersed in the fourth polymer, wherein each of the clay fragments is capable of being water-resistant and oxygen-resistant.

In one embodiment, the first polymer comprises an acrylic resin.

In one embodiment, the second polymer comprises an acrylic resin.

In one embodiment, the first base film 304 is a plastic film.

In one embodiment, the second base film 305 is a plastic film.

In one embodiment, the third coating layer 306 has a first major surface comprising a structured surface 304M.

In one embodiment, the fourth coating layer 307 has a second major surface comprising a structured surface 305M.

In one embodiment, the clay fragments comprise at least one of the following materials: glass flakes, mica, montmorillonite, talc, calcium silicate, aluminum silicate.

In one embodiment, the concentration of the clay fragments is 0.05 to 10 wt %.

In one embodiment, the concentration of the clay fragments is 0.1 to 5 wt %.

In one embodiment, a plurality of diffusion particles 301D are dispersed in the binder 301B.

In one embodiment, the diffusion particles can be organic particles, such as PMMA, PS, Melamine, etc.

In one embodiment, the diffusion particles can be inorganic particles, such as Silicon, SiO2, TiO2, CaCO3, Al2O3, ZrO2, etc.

In one embodiment, the diffusion particles can be organic particles, such as PMMA, PS, Melamine, etc., or inorganic particles, such as Silicon, SiO2, TiO2, CaCO3, Al2O3, ZrO2, etc. The concentration can be from 2 to 40%, and the best is 5-15%.

In one embodiment, the diffusion particles can be organic particles, such as PMMA, PS, Melamine, etc., or inorganic particles, such as Silicon, SiO2, TiO2, CaCO3, Al2O3, ZrO2, etc. The concentration can be from 2 to 40 wt %, and the best is 5-15 wt %.

In one embodiment, the thickness of quantum dot optical film ranges from 25 μm to 350 um.

The material of the binder 301B should be selected such that the quantum dots 301A are protected from damage caused by oxygen or water. In one embodiment, the material of the binder 301B can include at least one of the following: PET (polyethylene terephthalate), PEN (polyethylene naphtholate), PAR (polyacrylate), PC (polycarbonates), and TAC (cellulose triacetate). Preferably, the material is PET (polyethylene terephthalate). The material can be pure PET (polyethylene terephthalate). The material of the binder 301B can be unitary or homogeneous.

In one embodiment, the quantum dots 301A can comprise green quantum dots and red quantum dots. The material of the quantum dots 301A can comprise CdS, CdSe, CdTe, ZnSe, PbS, PbSe, InP, InAs, InGaP, ZnS, or ZnTe, but the present invention is not limited thereto. The material of the quantum dots 301A can comprise Cd (e.g., CdSe) or be Cd-free (e.g., InP).

In one embodiment, the concentration of the quantum dots 301A can be in the range from 0.1% to 20%, preferably, from 0.3 to 8 wt %.

In one embodiment, the concentration of the quantum dots 301A in the quantum-dot layer 301 is 0.05-20 wt %.

In one embodiment, the concentration of the quantum dots 301A in the quantum-dot layer 301 is 0.05-8 wt %.

In one embodiment, the thickness of the quantum-dot optical film is 25-350 um.

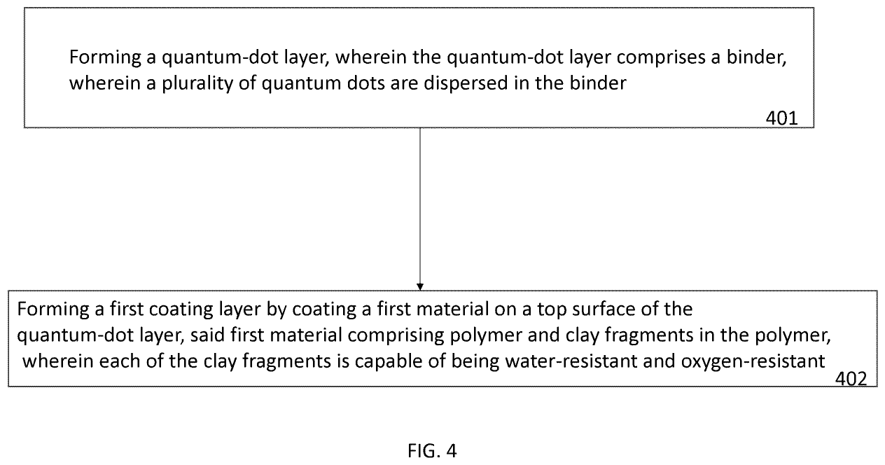

In one embodiment, as shown in FIG. 4, a method to form a quantum-dot optical film, said method comprising: step 401: forming a quantum-dot layer, wherein the quantum-dot layer comprises a binder, wherein a plurality of quantum dots are dispersed in the binder; and step 402: forming a first coating layer by coating a first material on a top surface of the quantum-dot layer, said first material comprising polymer and clay fragments in the polymer, wherein each of the clay fragments is capable of being water-resistant and oxygen-resistant.

In one embodiment, the method further comprises forming a second coating layer by coating a second material on a bottom surface of the quantum-dot layer, said second material comprising a polymer and clay fragments in the polymer, wherein each of the clay fragments is capable of being water-resistant and oxygen-resistant.

In one embodiment, the outer surface of each of the first plurality of clay fragments 202L is modified to be capable of being water-resistant and oxygen-resistant.

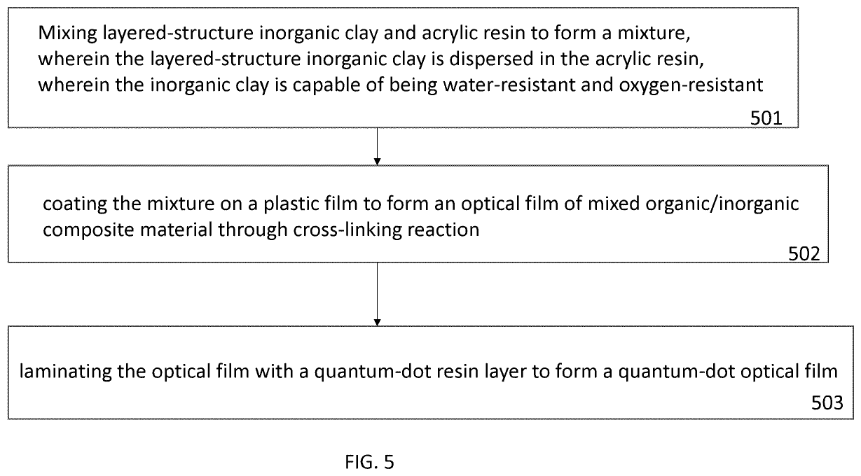

In one embodiment, as shown in FIG. 5, a method to form a quantum-dot optical film, wherein the method comprises: step 501: mixing layered-structure inorganic clay and acrylic resin to form a mixture, wherein the layered-structure inorganic clay is dispersed in the acrylic resin, wherein the inorganic clay is capable of being water-resistant and oxygen-resistant; step 502: wet coating the mixture on a plastic film to form an optical film of mixed organic/inorganic composite material through cross-linking reaction; and step 503: laminating the optical film with a quantum-dot resin layer to form a quantum-dot optical film.

After the cross-linking reaction, the layered-structure inorganic clay and the acrylic resin achieve nano-scale dispersion, which can be applied to the plastic optical film through a coating process. At the same time, it is compatible with the mechanical properties and light transmittance of the original plastic optical film, which can reflect the high optical conversion effect of quantum dots, thus helping to improve the application and popularity of quantum-dot optical films in the display field. For organic/inorganic composite optical films, the layered structure of the inorganic clay can effectively inhibit the linear diffusion path of gas, and its gas barrier rate can be increased by more than 70%, which helps to improve the reliability and stability of quantum-dot optical films with the advantages of simple process, low cost, and good adhesion.

In one embodiment, the clay polymer can be formed by cross-linking of two monomers, which is dispersed in the barrier film. The clay particle formation method can be an exchange of ions, etc. The clay dispersion can be directly added to a solvent, and the clay and the solvent can be fully and evenly mixed. Clay a combination of the following materials: smectite, mica clay, vermiculite clay, montmorillonite clay, iron-containing montmorillonite clay, beidellite clay, saponite clay, hectorite clay, pyroxene clay, Nontronite Clay, Anionic Clay, Zirconium Phosphate, Kaolinite, Attapulgite, Illite, Halloysite, Diatomaceous Earth, Fuller's Earth, Calcined Aluminum Silicate, Hydrated Aluminum Silicate, Aluminum Magnesium Silicate, Sodium Silicate and magnesium silicate, or a combination thereof.

In one embodiment, the average thickness of clay particles is in the range of 100 nm-400 nm. In one embodiment, solvents can be ether solvents, ketone solvents, alcohol solvents, etc. In one embodiment, the ratio of clay particles to solvent is 1:100˜1:25. In one embodiment, the solvent can comprise at least one of the following: ether solvent, ketone solvent, and alcohol solvent.

In one embodiment, the base film can comprise at least one of the following: PET, PEN, PAR, PC, TAC . . . etc.

In one embodiment, the base film is an optical film, and the coating layer is coated on the optical film, to form an optical barrier film.

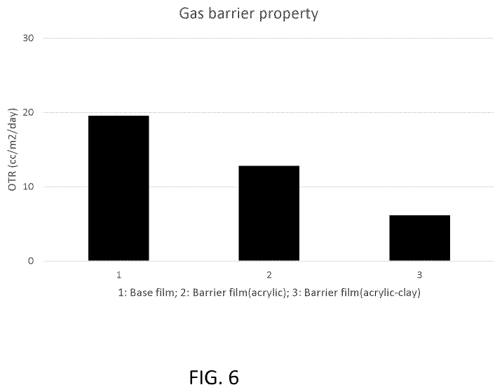

As shown in FIG. 6, the barrier film is based on acrylic-clay material has the lowest penetrating rate of water-oxygen compared with the base film and the barrier film without clay.

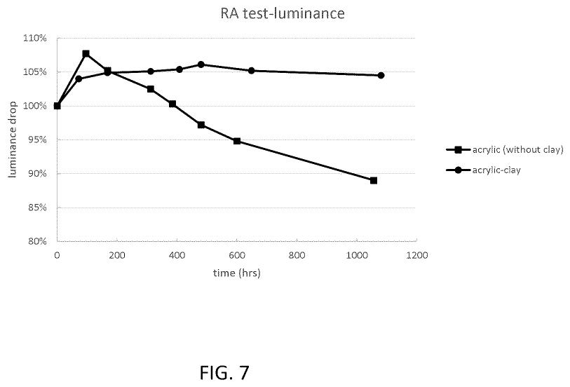

As shown in FIG. 7, the luminance is higher when the barrier film is based on acrylic-clay material compared with the barrier film without clay.

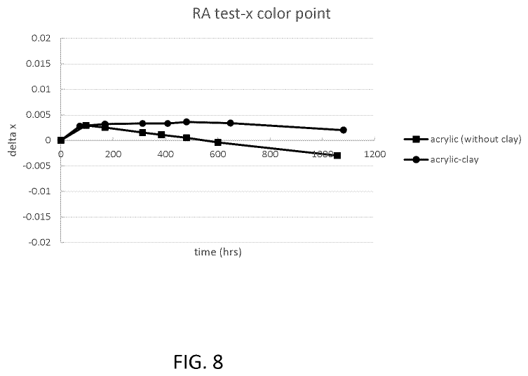

As shown in FIG. 8, the degradation of x-color is slower when the barrier film is based on acrylic-clay material compared with the barrier film without clay.

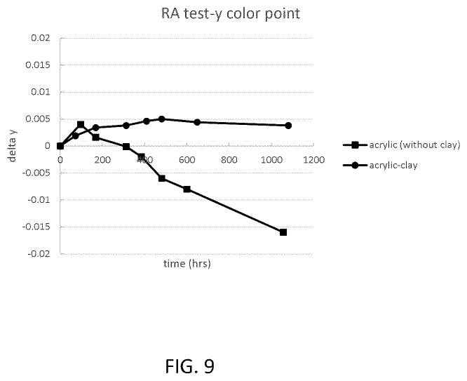

As shown in FIG. 9, the degradation of y-color is slower when the barrier film is based on acrylic-clay material compared with the barrier film without clay.

Compared with the conventional barrier film, the barrier film of the present invention has a relatively easy manufacturing process and can have good adhesion with the quantum dot layer without the need for surface adhesion treatment.

The addition of clay particles does not affect the light transmittance of the original barrier film, and its light transmittance is still greater than or equal to 90%.

The barrier layer of the present invention can also be attached, injected, or laminated on the quantum dot film.

The advantage of the present invention includes the following: 1. after the cross-linking reaction, the layered structure of the inorganic clay and the acrylic resin achieve good nano-scale dispersion, which can be applied to the plastic optical film through the coating process. It is also compatible with the mechanical properties and light transmittance of the original plastic optical film substrate (increased data is greater than or equal to 90%), which can reflect the high optical conversion effect of quantum dots (increased data blue light conversion rate can reach 5-8%)), so it is more helpful to improve the application and popularity of quantum dot optical films in the display field in the future; 2. for the organic/inorganic composite optical film substrate, its inorganic clay layered structure can effectively inhibit the linear diffusion path of gas, and its gas barrier rate can be increased by more than 70%, which helps to improve the reliability of quantum dot optical film. Long-term stability (at least 1000 hours); 3. the optical barrier film of this coating type also includes a simple process (the two are described separately and differential wet coating vs. sputtering deposition), low cost (about 50% reduction in drop wet coating cost), and dense The advantages of good performance (add 100 grids of data 5B).

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A quantum-dot optical film comprising:
a quantum-dot layer, comprising a binder and a plurality of quantum dots dispersed in the binder;
a first base film and a first coating layer, wherein the first coating layer is coated on a top surface of the base film, wherein a bottom surface of the first base film is disposed on a top surface of the quantum-dot layer, wherein the first coating layer comprises a first polymer and clay fragments dispersed in the first polymer, wherein each of the clay fragments is capable of being water-resistant and oxygen-resistant.

2. The quantum-dot optical film according to claim 1, further comprises a second coating layer, wherein the second coating layer is coated on a bottom surface of the second base film, wherein a top surface of the second base film is disposed on a bottom surface of the quantum-dot layer, wherein the second coating layer comprises a second polymer and inorganic clay fragments dispersed in the second polymer, wherein each of the clay fragments is capable of being water-resistant and oxygen-resistant.

3. The quantum-dot optical film according to claim 2, further comprises a third coating layer coated on a top surface of the first base film, wherein the third coating layer comprises a third polymer and inorganic clay fragments dispersed in the third polymer, wherein each of the clay fragments is capable of being water-resistant and oxygen-resistant.

4. The quantum-dot optical film according to claim 3, further comprises a fourth coating layer coated on a bottom surface of the second base film, wherein the fourth coating layer comprises a fourth polymer and inorganic clay fragments dispersed in the fourth polymer, wherein each of the clay fragments is capable of being water-resistant and oxygen-resistant.

5. The quantum-dot optical film according to claim 2, wherein a thickness of the first coating layer is in a range of 5-60 um.

6. The quantum-dot optical film according to claim 2, wherein the clay fragment comprises at least one of the following materials: glass flakes, mica, montmorillonite, talc, calcium silicate, aluminum silicate.

7. The quantum-dot optical film according to claim 2, wherein the first base film comprises at least one of the following: PET (polyethylene terephthalate), PEN (polyethylene naphtholate), PAR (polyacrylate), PC (polycarbonates), or TAC (cellulose triacetate).

8. The quantum-dot optical film according to claim 7, wherein the second base film comprises at least one of the following: The base film may be PET, PEN, PAr, PC, and TAC. PET (polyethylene terephthalate), PEN (polyethylene naphtholate), PAR (polyacrylate), PC (polycarbonates), or TAC (cellulose triacetate).

9. The quantum-dot optical film according to claim 2, wherein the first coating layer has a first major surface comprising a first structured surface.

10. The quantum-dot optical film according to claim 9, wherein the second coating layer has a second major surface comprising a second structured surface.
